(19) United States
(12) Patent Application Publication
(10) Pub. No.: US 2019/0078248 A1
(43) Pub. Date: Mar. 14, 2019

(54) APPARATUS, METHOD OF USING, AND MAKING THE SAME

(71) Applicant: Tracie Bennitt, Divide, CO (US)

(72) Inventor: Tracie Bennitt, Divide, CO (US)

(21) Appl. No.: 16/127,063

(22) Filed: Sep. 10, 2018

Related U.S. Application Data
(60) Provisional application No. 62/556,003, filed on Sep. 8, 2017.

(51) Int. Cl. D06B 3/06; B05C 17/005; B05C 3/20; D06B 3/04

(52) U.S. Cl. CPC D06B 3/06; B05C 17/00583; B05C 17/00503; B65D 47/128; D06B 3/045; B65D 2251/0087; B65D 2547/063; B05C 3/20

(57) ABSTRACT

The present invention generally relates to apparatus and method for applying an adhesive material to a substrate material, and more particularly to a method and system for the application of an adhesive to beading thread, string, jute, silk, yarn combinations of the same or the like.

The present application claims the benefits of and priority, under 35 U.S.C. § 119(e), to U.S. Provisional Application Ser. No. 62/556,003 filed Sep. 8, 2017, this above-identified provisional patent application is fully incorporated herein by reference.

### BACKGROUND OF THE INVENTION

### Field of the Invention

The present invention generally relates to an apparatus and method for applying an adhesive material to a substrate material, and more particularly to a method and system for the application of an adhesive to beading thread, string, jute, silk, yarn, and combinations of the same or the like.

### SUMMARY OF THE INVENTION

Accordingly, the invention is directed to an apparatus, method of making and using the same that substantially obviates one or more of the problems due to limitations and disadvantages of the related art.

An advantage of the invention is to provide users with an apparatus to easily create needles out of their substrate materials, e.g., beading thread, thereby increasing productivity and making their creative process much easier to implement, without fear of adhesive contamination on their fingers, beads or work area.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of creating an instaneedle from a substrate. The method includes obtaining a first container with a primer adhesive having a first viscosity and a first cap. Obtaining a second container with an adhesive having a second viscosity more than the first viscosity and a second cap. Removing the first cap from the first container and removing the second cap from the second container. Arranging and securing a first applicator on the first container where the first applicator includes a first end, a second end, a main body, an applicator tip extending from the main body to the first end, the first end of the applicator tip including an orifice in communication an internal lumen extending from the first end to the second end. Arranging and securing a second applicator on the second container where the second applicator includes a first end, a second end, a main body, an applicator tip extending from the main body to the first end, the first end of the applicator tip including an orifice in communication with an internal lumen extending from the first end to the second end. Arranging a predetermined portion of a substrate through the orifice of the first applicator and into the primer adhesive of the first container for a first predetermined amount of time. Removing the substrate while simultaneously squeezing a portion of the first applicator tip to remove excess primer adhesive. Allowing the substrate coated with the primer adhesive to dry for a second predetermined amount of time. Arranging a predetermined portion of the dried coated substrate with the primer adhesive through the orifice of the second applicator and into the adhesive of the second container for a third predetermined amount of time. Removing the substrate dried coated substrate while simultaneously squeezing a portion of the second applicator tip to remove excess adhesive allowing the substrate coated with the adhesive to dry for a fourth predetermined amount of time.

In another aspect of the present invention, a method of creating a needle portion from a fiber or fibrous cord material including obtaining a container with a cyanoacrylate adhesive having a low viscosity and arranging and securing a first applicator on the container. The applicator includes a first end, a second end, a main body, a conical applicator tip extending from the main body to the first end, the first end of the conical applicator tip including an orifice in communication an internal lumen extending from the first end to the second end. The method further includes arranging a predetermined length of the fiber or fibrous cord material through the orifice of the conical applicator tip and into the cyanoacrylate adhesive of the container for a first predetermined amount of time, wherein the predetermined length is substantially equal to the desired length of the needle portion. Removing the substrate while simultaneously squeezing a portion of the applicator tip near the first end to remove excess cyanoacrylate material on the fiber or fibrous cord material and allowing the substrate coated with the cyanoacrylate material to dry for a second predetermined amount of time.

In another aspect of the present invention, an instaneedle kit, including a thermoform housing, a first container with a primer adhesive having a first viscosity and a first cap and a second container with an adhesive having a second viscosity greater than the first viscosity and a second cap. The kit also includes a first applicator including a first end, a second end, a main body, an applicator tip extending from the main body to the first end, the first end of the applicator tip including an orifice in communication an internal lumen extending from the first end to the second end. The kit further includes a second applicator including a first end, a second end, a main body, an applicator tip extending from the main body to the first end, the first end of the applicator tip including an orifice in communication with an internal lumen extending from the first end to the second end. Optionally includes instructions for use.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an exemplary illustration of an apparatus according to an embodiment of the invention.

FIG. 2 illustrates a perspective exemplary view of an applicator tip according to FIG. 1 according to an embodiment of the invention.

FIG. 3 illustrates a bottom perspective exemplary view of an applicator tip according to FIG. 1 according to an embodiment of the invention.

FIG. 4 illustrates a top perspective exemplary view of an applicator tip according to FIG. 1 according to an embodiment of the invention.

FIG. 5 illustrates a top perspective exemplary view of an applicator with a cap according to an embodiment of the invention.

FIG. 6 illustrates a perspective exemplary view of an applicator tip and partial cross-section section view of a cap according to an embodiment of the invention.

FIG. 7 illustrates a partial cross-sectional exemplary view of an applicator tip and a cap according to an embodiment of the invention.

FIG. 8 illustrates an exemplary method of using an apparatus according to an embodiment of the invention.

FIG. 9 illustrates a method of inserting a substrate material into an apparatus according to an embodiment of the invention.

FIG. 10 illustrates a method of inserting a substrate material into an apparatus according to an embodiment of the invention.

FIG. 11 illustrates a method of removing a substrate material from an apparatus according to an embodiment of the invention.

### DETAILED DESCRIPTION OF THE ILLUSTRATED EMBODIMENTS

This invention relates to an apparatus, method of making and using the same. The apparatus includes an applicator with an applicator tip for the application of a fluid product, e.g., adhesive.

One embodiment is directed towards using the apparatus for use with arts and crafts, e.g., threading a bead onto (beading) a substrate like cord, thread, string, jute, silk or yarn by creating an instaneedle. Currently in the craft industry when beading a cord there is difficulty in creating or keeping stiff needle-like end on cords or threads to allow a user to string beads in the craft and jewelry industry. The ends of cords or threads can also fray when handled or repeatedly handled. As known in the art, some of the beads have very small holes which increases the difficulty in getting a thread to string through the bead easily. Also, using a needle is not possible as it pulls a double width of the thread through the bead, once again making it difficult to string very small beads. Aspects of the invention are directed towards improving or solving this problem.

One embodiment is directed towards creating and using an instaneedle with the substrate itself instead of using a needle. The instaneedle is created with the apparatus using a single stage or two-stage adhesive system. With a two-stage adhesive system the apparatus uses two applicators. In one implementation, each apparatus would include an applicator with an applicator tip configured to allow the user to easily stiffen and harden at least a portion of the substrate without getting any of the adhesive on the fingers of the user and/or the work area.

The adhesives are configured to allow a substrate to become stiff and rigid, thereby allowing a crafter/jeweler or user to apply beads or decorative items to the substrate without the use of a needle. The substrate for use in creating an instaneedle may be a cord, thread, string, jute, silk, yam, a combination of the same or the like.

In one implementation, the applicator and applicator tip allow a crafter/jeweler to use the applicator tip rather than their fingers to clean off any excess material from the substrate. With the apparatus a user can insert their substrate material into an orifice of the bottle and then gently pull the thread back out while simultaneously squeezing the applicator tip to strip the excess fluid off the thread without touching the thread or other material with their fingers or other item. This also allows a user to avoid getting adhesive on their fingers or work area as it is an inconvenience for users as well as the potential for damaging materials in the work area.

The applicator is constructed from a flexible thermoplastic material, e.g., low density polyethene, high density polyethene, polypropylene, polymer, thermosoftening or setting polymer, nylon, acrylic, ABS, Nylon™, PLA, polystyrene, Teflon™, polytetrafluoroethylene, combinations of the same.

In one embodiment, the applicator is coated with an anti-friction material to mitigate adhesion of the adhesive, e.g., Teflon™, polytetrafluoroethylene, and combinations of the same or the like.

In one embodiment, the adhesive may be applied with single stage system or a two-stage system. When using a two-stage system a user can use two apparatus as described herein. The first adhesive is a primer adhesive and includes a cyanoacrylate material. The primer adhesive has a very low viscosity in a range from about 5 centipoise (cP) to about 25 centipoise (cP) or less. The adhesive is strong and has a viscosity greater than the primer adhesive. The viscosity of the primer adhesive is configured to allow the primer adhesive to penetrate material including but not limited to fibers, fibrous material or other material of the substrates described herein. When using a beading material, the primer adhesive penetrates fiber of fibrous material of the beading material, e.g., thread, thereby creating a strong bonding base for the second application. Some the substrates treated with the primer adhesive will become strong enough and create a needle-like structure or instaneedle with just one application or single stage application.

The second adhesive includes a cyanoacrylate material having a viscosity in a range from about 75 centipoise (cP) to about 120 centipoise (cP) or greater. In a preferred embodiment the viscosity is a range from about 95 centipoise (cP) to about 120 centipoise (cP).

The apparatus can also include a container configured to be releasably coupled to the applicator. The container may be any size bottle configured to hold a fluid material weighing about 1 gm to about 54 gm or greater, e.g., a 5 gm sized bottle, a 10 gm sized bottle, a 27 gm sized bottle, and a 54 gm sized bottle. The fluid may be any fluid, e.g., adhesive, glue, primer adhesive or combinations of the same. Embodiments of the invention are also configured to solve numerous problems, e.g., how to make a needle stiff and hard to be able to easily string beads on it, without the thread bending or failing while trying to bead. The other issue was how to apply the adhesive to the thread without getting it on your fingers or in your work area.

Reference will now be made in detail to an embodiment of the present invention, example of which is illustrated in the accompanying drawings.

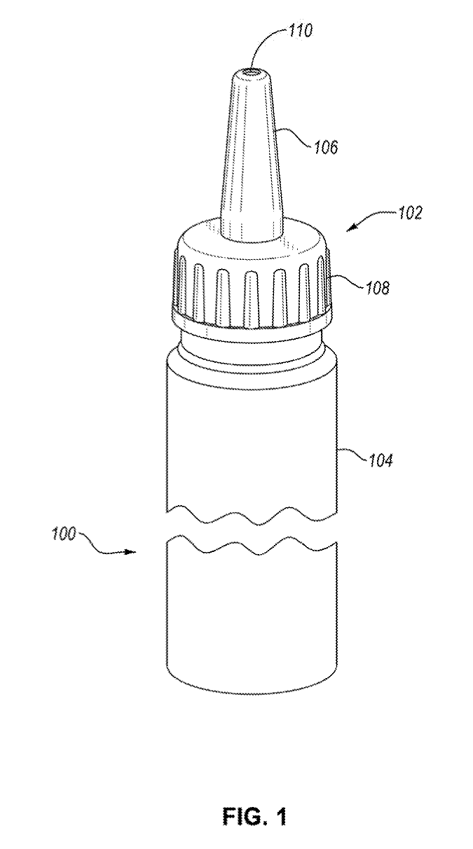

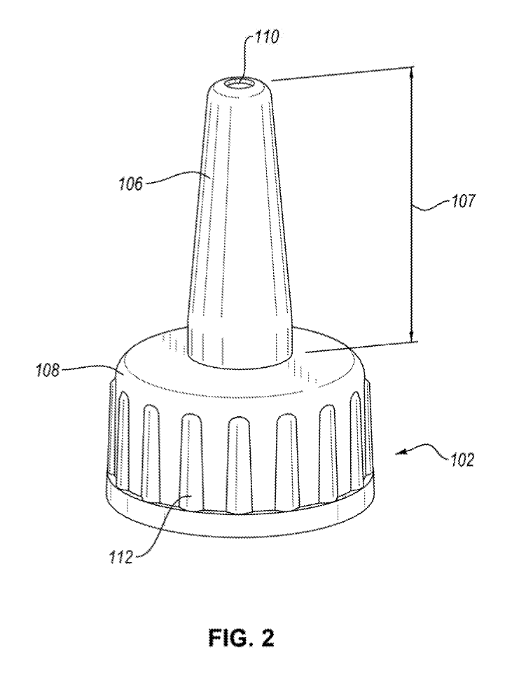

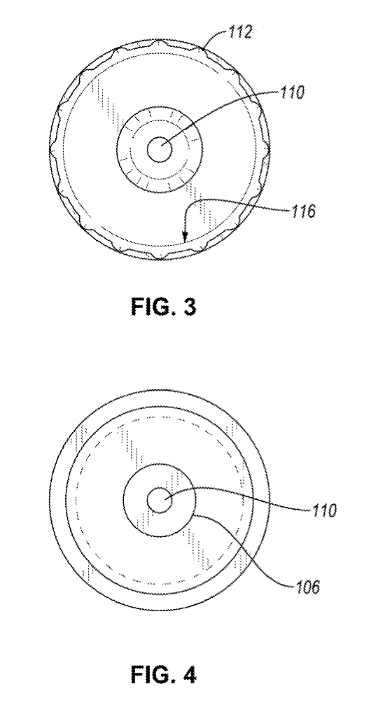

FIG. 1 illustrates an exemplary illustration of an apparatus according to an embodiment of the invention. FIG. 2 illustrates a perspective exemplary view of an applicator tip according to FIG. 1 according to an embodiment of the invention. FIG. 3 illustrates a bottom perspective exemplary view of an applicator tip according to FIG. 1 according to an embodiment of the invention. FIG. 4 illustrates a top perspective exemplary view of an applicator tip according to FIG. 1 according to an embodiment of the invention.

Referring to FIGS. 1-4, an apparatus is generally depicted with reference to number 100. The apparatus includes a container 104 and an applicator 102. The applicator 102 includes an applicator tip 106. The main body of the container is sized to hold a predetermined volume of a desired material, e.g., adhesive material. In a preferred embodiment the desired material includes an cyanoacrylate adhesive material.

The container 104 is formed from a thermoplastic material, e.g., high-density polyethylene (HDPE) material, and may be any color, transparent or semi-transparent. The container 104 further includes an attachment mechanism (not shown). The attachment mechanism may be any attachment mechanism known in the art, e.g., threads, snap fit mechanism, compression fit mechanism, or combinations of the same.

The attachment mechanism (not shown) of the container 104 is configured to engage the attachment mechanism 116 of applicator 102. The attachment mechanism 116 may be any mechanism known in the art, e.g., threads, snap fit mechanism, compression fit mechanism, combinations of the same. Optionally and/or alternatively, the applicator 102 and container 104 are an integral unit where they are not removable from each other. In one implementation, the apparatus further includes a travel or storage cap with a stopper to cover the applicator, e.g., cap.

The applicator 102 includes tip 106 and main body 108 having an outside diameter greater than the applicator tip 106. Optionally, the main body 108 includes a plurality of ridges 112 or other ergonomic feature configured to provide a user with grip, traction and/or other ergonomic reason. The applicator tip 106 includes an orifice 110 and its dimension is in a conical configuration. The applicator tip has a length 107. The length 107 may be in range from about 1 mm to about 100 mm or greater. In another embodiment, the applicator tip 107 can be in any geometric configuration and in a non-tapered configuration with a constant outside diameter.

The applicator tip 106 includes an orifice 110 sized to receive a substrate. The substrate is any desired material that is configured to be inserted into through an orifice 110 of the applicator tip 106. The orifice 110 allows for fluid communication via a lumen 120 or channel to the container 104.

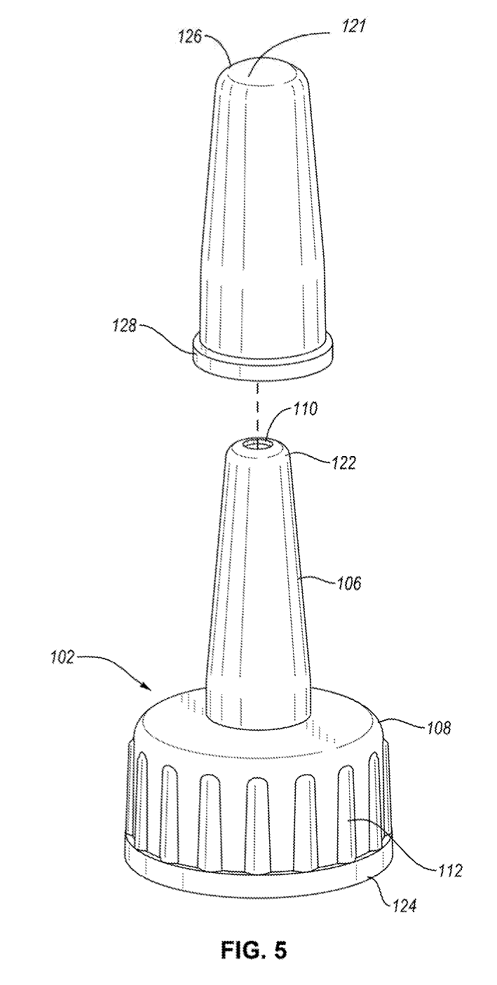

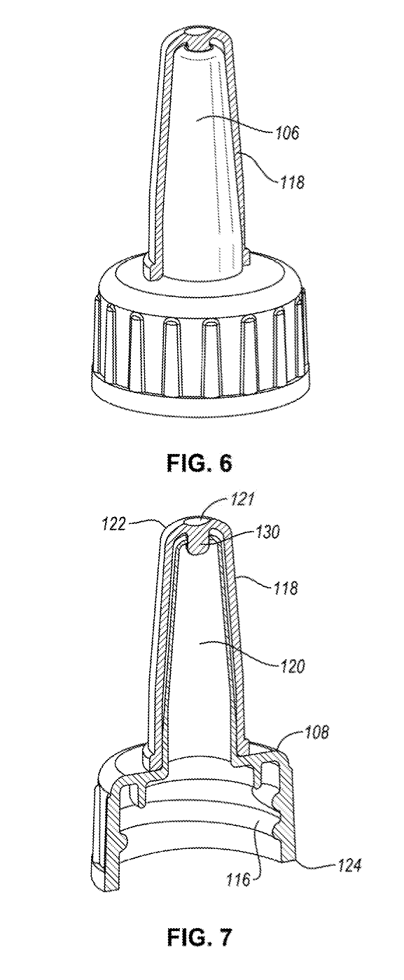

FIG. 5 illustrates an exemplary view of an applicator tip according to an embodiment of the invention. FIG. 6 illustrates a perspective exemplary view of an applicator tip and partial cross-section sectional of a cap according to an embodiment of the invention. FIG. 7 illustrates a partial cross-sectional exemplary view of an applicator tip and a cap according to an embodiment of the invention.

Referring to FIGS. 5-7, the orifice 110 is sized to receive a portion of the substrate into and through a lumen 120, so the substrate can be placed in the container 104. In one implementation, the applicator 102 includes a first end 122, a second end 124, and a lumen 120 extending from the first end or orifice 110 to the end second end 124 of the applicator 102. Optionally, the apparatus further includes a cap 118 configured to fit securely over the applicator tip 106.

In one implementation, the cap 118 is dimensioned to snap in place over the applicator having a resistance fit as known in the art. The cap 118 includes a closed first end 126 and an open second end 128. The first end 126 includes an optional color-coded region 121. The color-code region 121 is configured to indicate ingredients in the container 104. The color can be any color, e.g., red, green, blue or any combination of the same. In addition, referring to FIG. 6, the cap 118 has a protrusion 130 sized to fit securely in and through at least a portion of the orifice 110. The protrusion 130 includes a flexible material sized to be the same dimension or slightly larger dimension than the size of the orifice 110. The cap 118 includes a thermoplastic material, e.g., high-density polyethylene (HDPE). The cap can also be any color as described herein and also coordinated with the color-coded region 121.

Optionally and/or alternatively, an implementation may include a kit having a thermoform sized to hold one or more containers and one or more applicator tips. In one implementation the kit is an instaneedle kit including a system for creating a needle from a beading thread or cord. The kit includes a first container including an adhesive primer and a second container containing an adhesive. The adhesive primer includes an adhesive having a low viscosity configured to allow penetration in the substrate. The adhesive is strong and the viscosity is less than the viscosity of the adhesive in the second container. The viscosity is configured to allow the primer adhesive to penetrate fibers of the thread creating a strong bonding base for the second application. Some threads will create a strong enough needle with just this first application of adhesive. The kit optionally further includes a second container with an adhesive that has a viscosity greater than the viscosity of the adhesive primer. The first container and second container include travel or storage caps, and the kit also includes two applicators and instructions for use. The travel or storage caps are utilized when traveling or storing the product and configured to allow the produce to have a longer shelf life. In one embodiment, the storage or travel cap comprises a thermoplastic, e.g., high-density polyethylene (HDPE) or polyethylene high-density (PEHD).

Optionally, the kit can further include a debonder. The debonder includes acetone, nitromethane, and combinations of the same configured to be applied to a cotton material, synthetic material, cloth material, sponger or other applicator and can be used to wipe off excess adhesive from the applicator tip. It also removes cured adhesive from the user's fingers or other surfaces.

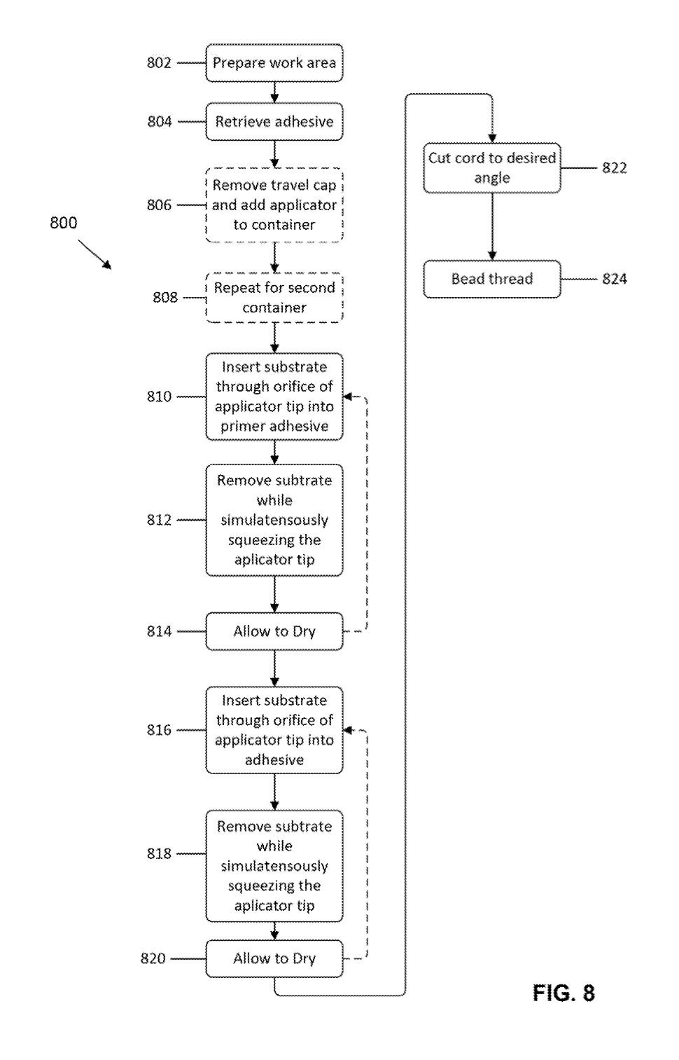

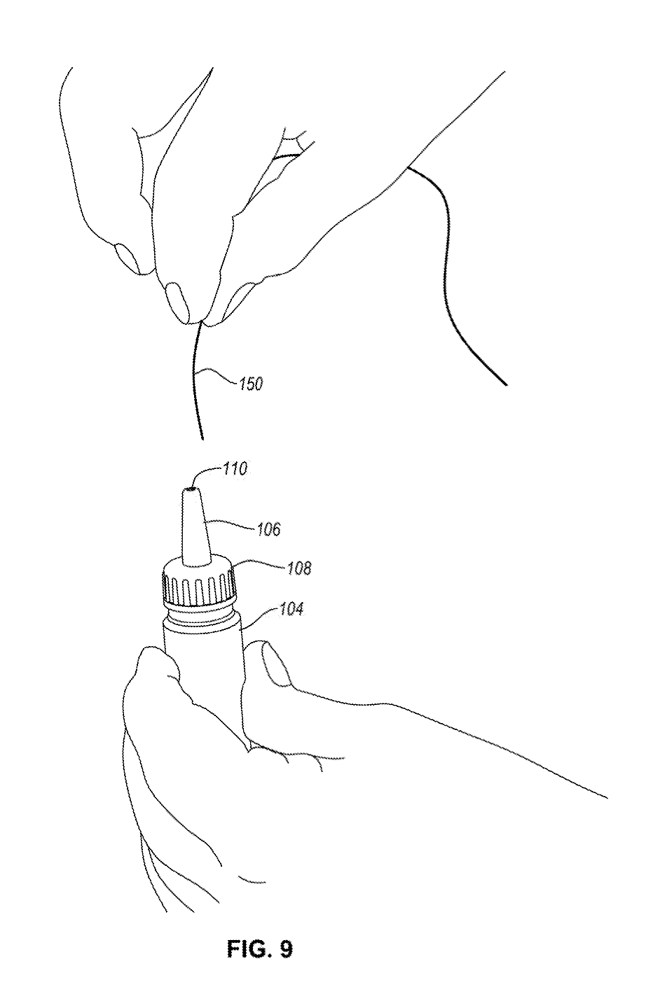

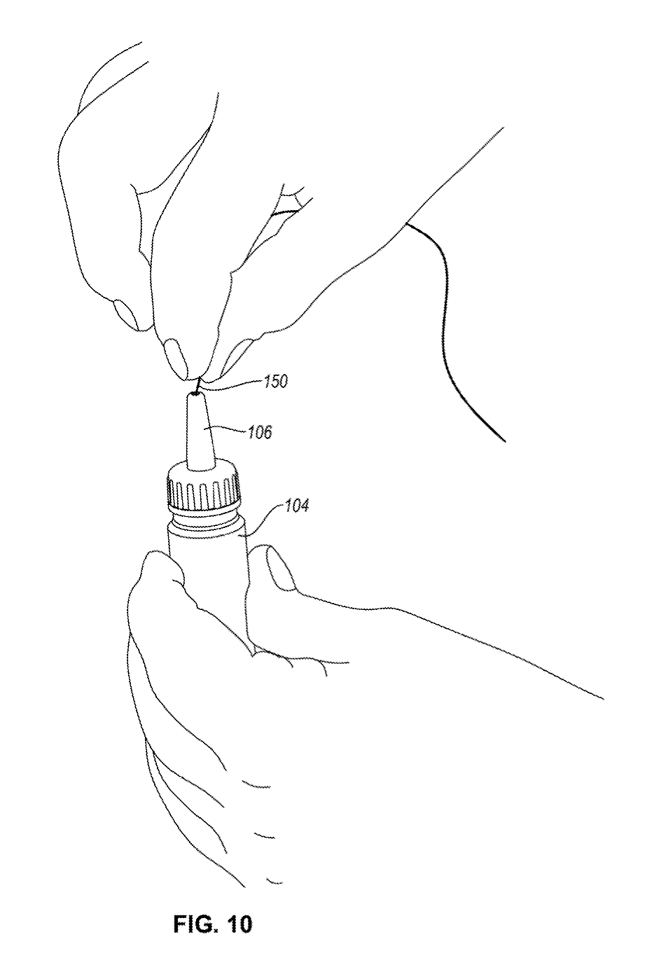

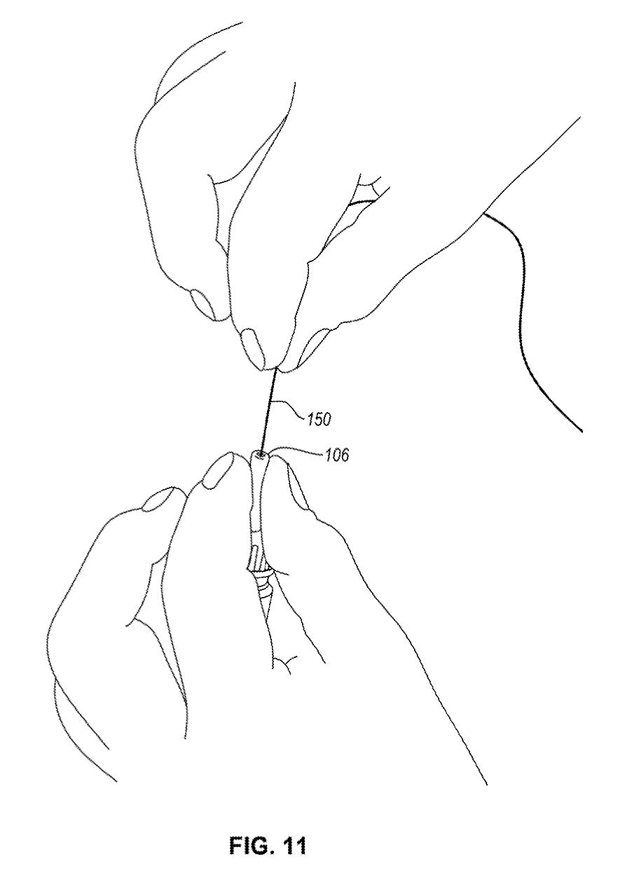

FIG. 8 illustrates an exemplary method of using an apparatus according to an embodiment of the invention. FIG. 9 illustrates an exemplary method of using an apparatus according to an embodiment of the invention. FIG. 10 illustrates a method of inserting a substrate material into an apparatus according to an embodiment of the invention. FIG. 11 illustrates a method of inserting a substrate material into an apparatus according to an embodiment of the invention. FIG. 12 illustrates a method of removing a substrate material from an apparatus according to an embodiment of the invention.

Referring to FIG. 8, the method of forming and an using an instaneedle according to an embodiment is shown. The method is generally depicted with reference to number 800.

The method 800 includes preparing a work area or work surface in step 802. The instaneedle is a rigid portion of a substrate, e.g., a needle portion on the end of the cord, one or more fibers, beading thread, string, jute, silk, yarn, combinations of the same and the like. The instaneedle allows a user to add objects or thread objects onto the substrate without the need for a needle. The objects or items include, e.g., beads or other decorative items. The work surface can include a pad or other surface, e.g., a reduced friction pad, e.g., a Teflon™ pad, which is configured to prevent adhesive from permanently bonding to the surfaces.

In step 804, the user obtains or retrieves the adhesive material in a container. The adhesive can be more than one adhesive in more than one container. The adhesive can be a single stage adhesive or two-stage adhesive. In this implementation, two containers are retrieved. The first container has a primer adhesive with a low viscosity and the adhesive in the second container has an adhesive with a viscosity greater than the primer adhesive viscosity. The first and second adhesive materials can include cyanoacrylates.

Optionally, the adhesive of the first and second containers can be provided in a container with a travel or storage cap (not shown). The travel or storage cap is a cap utilized to directly engage threads of the container and create a seal or bond configured to extend the shelf-life of the adhesive and prevent spillage. In this embodiment, the first and second containers include travel or storage caps.

The travel or storage cap of the first container having the primer adhesive is unscrewed and the applicator 102 is screwed onto the container in step 806. Next, the travel or storage cap of the second container having the second adhesive is unscrewed and the applicator 102 is screwed onto the second container in step 808. Steps 806 and/or step 808 are optional and the containers can include applicators without travel or storage caps.

Next, in step 810 and as shown in FIGS. 9-11, the substrate 150, e.g., one or more fibers, cord, beading thread or the like, is interested through the orifice 110 and lumen 120 of the applicator 106 tip and into the container 104 such that a portion of the cord remains submerged in the primer adhesive for a predetermined period of time, e.g., 0.1 second to about 10 seconds or more. If necessary, the user may trim the end of the cord prior to insertion to eliminate any frayed ends. The length of the cord submerged in the adhesive should be approximately equal to the length of the desired instaneedle.

Also, the greater the amount of time the cord remains in the container the greater the absorption of the adhesive primer into the cord or fibers of the cords. The container 104, in a preferred embodiment, is clear or visually transparent to allow a user to observe the cord submerged in the adhesive primer.

After the predetermined time period, in step 812 the user removes the cord while simultaneously squeezing or pinching an upper portion of the applicator tip 106 near the first end 122 or even directly adjacent the first end 122 as shown in FIG. 11. The squeezing or pinching changes the inner diameter of the lumen 120 in the region being squeezed to allow the inner diameter to touch and/or compress at least a portion of the cord. This allows any excess adhesive primer to be removed from the cord. The cord is now allowed to dry (step 814) for a predetermined time of about 1 to 2 mins or greater. This process may be repeated as shown with the dashed line.

To further increase the strength of the instaneedle the following optional steps may be preferred. In step 816, the dried cord is interested through the orifice 110 and lumen 120 of the applicator 106 tip of the second container such that a portion of the cord remains submerged in the adhesive for a predetermined period of time, e.g., 0.1 second to about 10 seconds or more. The second container, in a preferred embodiment, is clear or visually transparent to allow a user to observe the cord submerged in the adhesive.

After the predetermined time period and in step 818 the user removes the cord while simultaneously squeezing or pinching an upper portion of the applicator tip 106 near the first end 122 or even directly adjacent the first end 122. The squeezing or pinching changes the inner diameter of the lumen 120 in the region being squeezed to allow the inner diameter to touch and/or compress at least a portion of the cord. This allows any excess adhesive to be removed from the cord. The cord is now allowed to dry (step 820) for a predetermined time of about 1 to 2 mins or greater. This process may be repeated as shown with the dashed line.

Next, in step 822, the cord will include a region that is stiff and rigid. An end portion of the cord is cut at an angle to create a sharp or needle-like tip. The tip is an instaneedle. In step 824, the user can use the instaneedle for any beading project or other project.

The inventions and methods described herein can be viewed as a whole, or as a number of separate inventions, that can be used independently or mixed and matched as desired. All inventions, steps, processes, devices, and methods described herein can be mixed and matched as desired. All previously described features, functions, or inventions described herein or by reference may be mixed and matched as desired.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of creating an instaneedle from a substrate, comprising the steps of:
obtaining a first container with a primer adhesive having a first viscosity and a first cap;
obtaining a second container with an adhesive having a second viscosity more than the first viscosity and a second cap;
removing the first cap from the first container;
removing the second cap from the second container;
arranging and securing a first applicator on the first container, wherein the first applicator includes a first end, a second end, a main body, an applicator tip extending from the main body to the first end, the first end of the applicator tip including an orifice in communication an internal lumen extending from the first end to the second end;
arranging and securing a second applicator on the second container, wherein the second applicator includes a first end, a second end, a main body, an applicator tip extending from the main body to the first end, the first end of the applicator tip including an orifice in communication with an internal lumen extending from the first end to the second end;
arranging a predetermined portion of a substrate through the orifice of the first applicator and into the primer adhesive of the first container for a first predetermined amount of time;
removing the substrate while simultaneously squeezing a portion of the first applicator tip to remove excess primer adhesive;
allowing the substrate coated with the primer adhesive to dry for a second predetermined amount of time;
arranging a predetermined portion of the dried coated substrate with the primer adhesive through the orifice of the second applicator and into the adhesive of the second container for a third predetermined amount of time;
removing the substrate dried coated substrate while simultaneously squeezing a portion of the second applicator tip to remove excess adhesive; and
allowing the substrate coated with the adhesive to dry for a fourth predetermined amount of time.

2. The method of claim 1, further comprising the step of cutting a portion of the dried substrate coated with the adhesive at a predetermined angle.

3. The method of claim 1, further comprising the step of arranging one or more beads or decorative materials over the substrate.

4. The method of claim 1, wherein the applicator cap comprises a color-code portion indicative of either a primer adhesive or adhesive material.

5. The method of claim 1, wherein the primer adhesive comprises a cyanoacrylate material.

6. The method of claim 1, wherein the adhesive comprises a cyanoacrylate material.

7. The method of claim 1, wherein the first applicator tip further comprises a first cap with a color-coded region indicative of the primer adhesive.

8. The method of claim 1, wherein the second applicator tip further comprises a second cap with a color-coded region indicative of the adhesive.

9. The method of claim 1, wherein the substrate comprises one of a cord, a thread, a string, a jute, a silk, and a yam.

10. The method of claim 1, further comprising the steps of:
arranging a predetermined portion of the dried coated substrate with the adhesive through the orifice of the second applicator and into the adhesive of the second container for a fifth predetermined amount of time;
removing the substrate with the adhesive coating while simultaneously squeezing a portion of the second applicator tip to remove excess adhesive; and
allowing the substrate with the coated with the adhesive to dry for a sixth predetermined amount of time.

11. A method of creating a needle portion from a fiber or fibrous cord material, comprising the steps of:
obtaining a container with a cyanoacrylate adhesive having a viscosity;
arranging and securing a first applicator on the container, wherein the applicator includes a first end, a second end, a main body, a conical applicator tip extending from the main body to the first end, the first end of the conical applicator tip including an orifice in communication an internal lumen extending from the first end to the second end;
arranging a predetermined length of the fiber or fibrous cord material through the orifice of the conical applicator tip and into the cyanoacrylate adhesive of the container for a first predetermined amount of time, wherein the predetermined length is substantially equal to the desired length of the needle portion;
removing the substrate while simultaneously squeezing a portion of the applicator tip near the first end to remove excess cyanoacrylate material on the fiber or fibrous cord material; and
allowing the substrate with the coated with the cyanoacrylate material to dry for a second predetermined amount of time.

12. The method of claim 11, further comprising the step of cutting a portion of the dried substrate coated with the adhesive at a predetermined angle.

13. The method of claim 11, further comprising the step of arranging one or more beads or decorative materials over the substrate.

14. The method of claim 1, wherein the applicator further comprises an applicator cap having a color-code portion indicative of either a primer adhesive or adhesive material.

15. The method of claim 1, wherein the first viscosity is about 25 centipoise or less.

16. The method of claim 1, wherein the first viscosity is about 100 centipoise or greater.

17. An instaneedle kit, comprising:
a thermoform housing;
a first container with a primer adhesive having a first viscosity and a first cap;
a second container with an adhesive having a second viscosity less than the first viscosity and a second cap;
a first applicator including a first end, a second end, a main body, an applicator tip extending from the main body to the first end, the first end of the applicator tip including an orifice in communication an internal lumen extending from the first end to the second end;
a second applicator including a first end, a second end, a main body, an applicator tip extending from the main body to the first end, the first end of the applicator tip including an orifice in communication with an internal lumen extending from the first end to the second end; and
instructions for use.

18. The instaneedle kit of claim 17, wherein the first applicator further comprises a first applicator cap having a color-code portion indicative of the primer adhesive.

19. The instaneedle kit of claim 17, wherein the second applicator further comprises a second applicator cap having a color-code portion indicative of the adhesive.

20. The instaneedle kit of claim 17, further comprising a third container comprising a debonder.
